(19) United States
(12) Patent Application Publication
(10) Pub. No.: US 2006/0017189 A1
(43) Pub. Date: Jan. 26, 2006

(54) Molding arrangement and method including vacuum assisted ventilation

(75) Inventor: Alan G. Miller, South Easton, MA (US)

Correspondence Address: WILMER CUTLER PICKERING HALE AND DORR LLP, 60 STATE STREET, BOSTON, MA, 02109, US

(73) Assignee: Risco USA Corporation, South Easton, MA (US)

(21) Appl. No.: 11/106,370

(22) Filed: Apr. 14, 2005

Related U.S. Application Data
(60) Provisional application No. 60/563,179, filed on Apr. 16, 2004.

(51) Int. Cl. B29C 45/00

(52) U.S. Cl. 264/102; 425/546; 264/328.1

(57) ABSTRACT

An arrangement for molding products includes a mold defining a volume, the mold including an inlet leading to the volume for receiving product to be molded and an outlet for venting air from the volume, and a vacuum connected to the outlet. A method for molding products includes evacuating air from an outlet of a mold volume with a vacuum, and forcing product to be molded into the mold volume through an inlet of the mold volume.

### CROSS-REFERENCE TO RELATED APPLICATION

This application claims priority from provisional Ser. No. 60/563,179 filed Apr. 16, 2004, which is incorporated herein by reference.

### BACKGROUND AND SUMMARY

The present invention relates to an arrangement and method for molding products and, more particularly, to an arrangement and method for molding products with vacuum-assisted evacuation of air from the mold.

Certain molding or forming apparatus, such as those used in molding food materials such as ground meat and vegetables, comprise a shaping mold volume with an inlet for receiving a charge of the product to be molded and an escape passage for venting gas such as air from the mold volume while charging the volume with the product. U.S. Pat. No. 3,869,757, which is incorporated by reference, discloses an example of such a molding apparatus.

In accordance with an aspect of the present invention, an arrangement for molding products includes a mold defining a volume, the mold including an inlet leading to the volume for receiving product to be molded and an outlet for venting air from the volume, and a vacuum connected to the outlet.

In accordance with another aspect of the present invention, a method for molding products includes evacuating air from a mold volume through an outlet of the mold volume with a vacuum, and forcing product to he molded into the mold volume through an inlet of the mold volume.

When molding food products, it is desirable to avoid contact of the food products with air to minimize the possibility of contamination. Accordingly, it is desirable to vent gas such as air from a mold volume prior to charging the mold volume with the product.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic, partially cross-sectional view of an arrangement for molding products showing a mold member in a molding position;

FIG. 2 is a schematic, partially cross-sectional view of an arrangement for molding products showing a mold member in an ejection position; and

FIG. 3 is a schematic, partially cross-sectional view of an arrangement for molding products showing a mold member moving from an ejection position to a molding position.

### DETAILED DESCRIPTION

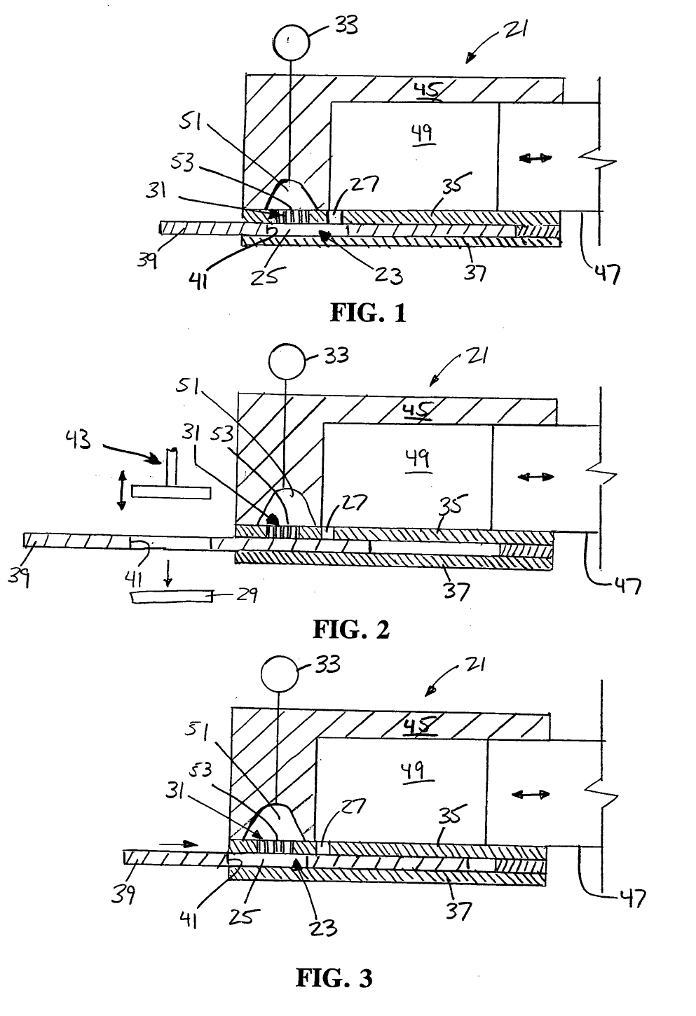

An arrangement 21 for molding products is seen in FIGS. 1 and 2 and includes a mold 23 defining a volume 25. The mold 23 includes an inlet 27 leading to the volume 25 for receiving product such as ground meat or vegetables to be molded and an outlet 31 for venting air from the volume. A vacuum device 33 is connected to the outlet 31. Though the present invention is described in connection with a preferred embodiment for forming food products into shapes such as patties, it will be appreciated that the present invention has application in a variety of molding applications. An example of a device with which the present invention is adapted to be used is described in U.S. Provisional Application No. 60/563,178, filed Apr. 16, 2004 and incorporated herein by reference.

The mold 23 preferably includes a top member 35 and a bottom member 37 and a mold member 39 including a cavity 41 disposed between the top member and the bottom member. The volume 25 is preferably defined by the cavity 41, the top member 35, and the bottom member 37. The mold member 39 is preferably movable relative to the top member 35 and the bottom member 37. The mold member 39 is preferably movable between a molding position (FIG. 1) in which the cavity 41 is disposed between the top and the bottom member 35 and 37 and an ejection position (FIG. 2) in which the cavity is not disposed between the top and the bottom member. As seen in FIG. 2, a punch 43 is preferably provided for removing molded products 29 from the cavity 41 when the mold member 39 is in the ejection position.

The inlet 27 and the outlet 31 are preferably in flow communication when the mold member 39 is in the forming position to facilitate venting of any air remaining in the cavity 41. Flow communication between the inlet 27 and the outlet 31 is preferably substantially blocked when the mold member 39 is in the ejection position.

The mold member 39 is preferably in the form of a plate and the cavity 41 is preferably an opening extending through the plate. The inlet 27 and the outlet 31 are preferably both provided in the top member 35, although the inlet 27 and/or the outlet 31 can, if desired or necessary, be in either the top or the bottom member 35 or 37 or both.

The top member 35 is preferably a breather plate forming part of a ram block 45 having a ram 47 and a rain cylinder 49 and, when the mold member 39 is in the molding position, the ram cylinder and the volume 25 communicate through the inlet 27. A surface of the top member 35 preferably defines a portion of the ram cylinder 49. The ram 47 forces the product from the cylinder 49 through the inlet 27 and into the volume 25. The bottom member 37 is preferably part of the ram block 47 or attached to the ram block. The outlet 31 preferably communicates with a ventilation volume 51 to which the vacuum 33 is attached. The arrangement 21 for molding products preferably includes the ram arrangement as well as a source of supply (not shown) of the product to be molded, such as a hopper that grinds meat and delivers it through a conduit under pressure by means such as a screw. The arrangement 21 for molding products may, however, include a ram arrangement that is integral with a hopper, or, if desired or necessary, the ram arrangement may be omitted and the hopper can supply the product to be molded to the mold 23 without an intermediate ram arrangement. The inlet 27 and the outlet 31 are preferably arranged relative to one another such that, when the mold member 39 moves from the ejection position to the molding position, the outlet of the mold volume 25 opens before the inlet of the mold volume as seen in FIG. 3. In this way, the vacuum 33 can evacuate air from the mold volume 25 through the outlet 31 before introduction of the product through the inlet begins, which can assist in avoiding contamination of certain food products. Also, the vacuum is believed to assist in causing the product to fill the mold volume 25 and to assist in providing a uniform consistency to the molded product.

The outlet 31 is preferably in the form of one or more, preferably a plurality of, outlet openings 53. Each of the outlet openings 53 is preferably substantially smaller than the inlet 27 so that the tendency will be for only air to enter the outlet openings 53 while the product that is introduced to the mold volume 25 will tend to remain in the mold volume.

In a method for molding products according to an embodiment of the present invention, air is evacuated from the outlet 31 of the mold volume 25 with a vacuum 33 and the product is forced into the mold volume through the inlet 27. When the mold member 39 is moved to the ejection position (FIG. 2) molded products are removed from the cavity 41, such as by a punch 43. When returning the mold member 39 to the molding position, the outlet 31 opens and air is evacuated from the mold volume 25 with the vacuum 33 before opening the inlet 27 of the mold volume opens.

While this invention has been illustrated and described in accordance with a preferred embodiment, it is recognized that variations and changes may be made therein without departing from the invention as set forth in the claims.

What is claimed is:

1. An arrangement for molding products, comprising:
a mold defining a volume, the mold including an inlet leading to the volume for receiving product to be molded and an outlet for venting air from the volume; and
a vacuum device connected to the outlet.

2. The arrangement for molding products as set forth in claim 1, wherein the mold includes a top member and a bottom member and a mold member including a cavity disposed between the top member and the bottom member, the volume being defined by the cavity, the top member, and the bottom member.

3. The arrangement for molding products as set forth in claim 2, wherein the mold member is movable relative to the top member and the bottom member.

4. The arrangement for molding products as set forth in claim 3, wherein the mold member is movable between a molding position in which the cavity is disposed between the top and the bottom member and an ejection position in which the cavity is not disposed between the top and the bottom member.

5. The arrangement for molding products as set forth in claim 4, further comprising a punch for removing molded products from the cavity when the mold member is in the ejection position.

6. The arrangement for molding products as set forth in claim 4, wherein the inlet and the outlet are in flow communication when the mold member is in the forming position.

7. The arrangement for molding products as set forth in claim 6, wherein flow communication between the inlet and the outlet is substantially blocked when the mold member is in the ejection position.

8. The arrangement for molding products as set forth in claim 2, wherein the mold member is a plate and the cavity is an opening extending through the plate.

9. The arrangement for molding products as set forth in claim 2, wherein the inlet is provided in the top member.

10. The arrangement for molding products as set forth in claim 9, wherein the outlet is provided in the top member.

11. The arrangement for molding products as set forth in claim 9, wherein the outlet is provided in the bottom member.

12. The arrangement for molding products as set forth in claim 2, wherein the inlet is provided in the bottom member.

13. The arrangement for molding products as set forth in claim 1, wherein the mold includes a mold member having a cavity, the mold member being movable between a molding position in which the inlet and the outlet are in flow communication, and an ejection position in which flow communication between the inlet and the outlet is substantially blocked.

14. The arrangement for molding products as set forth in claim 13, wherein the inlet and the outlet are arranged such that, when the mold member moves from the ejection position to the molding position, the outlet of the mold volume opens before the inlet of the mold volume.

15. The arrangement for molding products as set forth in claim 1, wherein the outlet includes one or more outlet openings, each of the outlet openings being substantially smaller than the inlet.

16. A method for molding products, comprising:
evacuating air from a mold volume through an outlet of the mold volume with a vacuum; and
forcing product to be molded into the mold volume through an inlet of the mold volume.

17. The method for molding products as set forth in claim 16, wherein the mold volume is defined by a top member, a bottom member, and a cavity of a mold member, the method comprising moving the mold member between a molding position in which the cavity is disposed between the tap and the bottom member and an ejection position in which the cavity is not disposed between the top and the bottom member.

18. The method for molding products as set forth in claim 17, further comprising removing molded products from the cavity when the mold member is in the ejection position.

19. The method for molding products as set forth in claim 16, wherein a mold defining the mold volume includes a mold member having a cavity, the method including moving he mold member between a molding position in which the inlet and the outlet are in flow communication and an ejection position in which flow communication between the inlet and the outlet is substantially blocked.

20. The method for molding products as set forth in claim 19, comprising opening the outlet of the mold volume and evacuating air from the mold volume with the vacuum before opening the inlet of the mold volume when moving the mold member from the ejection position to the molding position.
